(19) United States
(12) Patent Application Publication
(10) Pub. No.: US 2012/0043322 A1
(43) Pub. Date: Feb. 23, 2012

(54) TEMPERATURE MAINTENANCE SYSTEM

(76) Inventor: Jerry Glenn Peters, Pearl, MS (US)

(21) Appl. No.: 13/215,044

(22) Filed: Aug. 22, 2011

Related U.S. Application Data
(60) Provisional application No. 61/375,723, filed on Aug. 20, 2010.

(51) Int. Cl. A23C 3/02

(52) U.S. Cl. 220/212

(57) ABSTRACT

Disclosed is a temperature maintenance system with a plate that has heat retaining properties to assist in maintaining the temperature of food on the plate. A dome cover is also used in the temperature maintenance system that also assists in maintaining the temperature of food on the ceramic plate. The temperature maintenance system also utilizes a tray that has elevated portions to help prevent the plate and dome cover from sliding across the tray while in transit.

### CROSS-REFERENCE TO RELATED APPLICATION

The present application claims the benefit of U.S. Provisional Application Ser. No. 61/375,723, filed Aug. 20, 2011, by Jerry Glenn Peters, entitled TEMPERATURE MAINTENANCE SYSTEM, the disclosure of which is hereby incorporated herein by reference for all that it discloses and teaches.

### BACKGROUND

Plates are often heated or cooled when food is placed on them before the plates are served to a consumer. The desired increase or decrease in temperature of the plate is useful when food is prepared and later served to a customer. The increase or decrease in temperature of the plate is decided by the type of food being served. For example, ice cream is most desired to be served cold, and steak is most desired to be served hot.

When food is on a plate to be served, a dome can be used to cover the plate to help maintain a desirable temperature of the food. Domes can be used in settings where the food is prepared, and then delivered to a patron receiving room service such as in hospitals, nursing homes, and hotels.

### SUMMARY

An embodiment of the present invention may therefore comprise a dome for maintaining the temperature of food comprising: a cover having a plastic shell comprising a first inside portion and a second outside portion; a reflective insulated layer adjacently disposed in the inside portion of the plastic shell; a transparent inner shell capable of radiating infrared radiation, the transparent inner shell adjacently disposed over the reflective insulated layer so that heat is reflected from the reflective insulated layer causing the first cover to retain heat within an inside portion of the cover when the first cover is disposed on a surface.

An embodiment of the present invention may further comprise a method for maintaining the temperature of food comprising: providing a cover having a plastic shell having an inside portion and an outside portion; providing a reflective insulated layer adjacently disposed in the inside portion of the plastic shell; providing a transparent inner shell capable of radiating infrared radiation adjacently disposed over the reflective insulated layer so that heat is reflected from the reflective insulated layer; placing said cover over said food so that the cover retains heat in the cover when the cover is disposed on a surface.

An embodiment of the present invention may further comprise a temperature maintenance system for maintaining the temperature of food comprising: a ceramic plate containing heat activated materials to help retain heat within the ceramic plate so that the ceramic plate assists in providing a substantially constant temperature of the food disposed on the ceramic plate; a dome cover having a plastic surface that does not melt when exposed to an increase in temperature that is approximately equal to the temperature of the food disposed on the plate; a reflective insulated layer disposed adjacent to the plastic surface; a transparent inner shell capable of radiating infrared radiation disposed adjacent to the reflective insulating layer so that the reflective insulating layer radiates heat towards the ceramic plate.

An embodiment of the present invention may further comprise a method of maintaining the temperature of food comprising: providing a ceramic plate containing heat activated materials to help retain heat within the ceramic plate so that the ceramic plate assists in providing a substantially constant temperature of the food disposed on the ceramic plate; providing a dome cover having a plastic surface that does not melt when exposed to an increase in temperature that is approximately equal to the temperature of the food disposed on the plate; providing a reflective insulated layer disposed adjacent to the plastic surface; providing a transparent inner plastic shell that radiates infrared radiation, the transparent inner plastic shell disposed adjacent to the reflective insulating layer so that the reflective insulating layer radiates heat towards the ceramic plate.

An embodiment of the present invention may further comprise a method for transporting food on a tray comprising: providing a plate having a protruding foot located on a rear portion of the plate; providing a dome cover having edges so that the edges rest on the tray; providing elevated portions on the tray so that the protruding foot of the plate prevent the plate from sliding on the tray when the plate is disposed within the elevated portions and the elevated portions prevent the dome cover from shifting on the tray during transit when the dome cover is disposed on an outer portion of the elevated portions of the tray.

### BRIEF DESCRIPTION OF THE DRAWINGS

FIG. 1 is an isometric assembly view of an embodiment of a temperature maintenance system.

FIG. 2 is an isometric view of the tray and plate of FIG. 1.

FIG. 3 is an isometric view of FIG. 2 with a dome cover.

FIG. 4 is an isometric rear view of the plate illustrated in FIG. 1.

FIG. 5 is an isometric front view of a plate illustrated in FIG. 1.

FIG. 6 is a cross-sectional view of the dome cover of FIG. 1.

FIG. 7 is a cross-sectional view of the dome cover of FIG. 1.

FIG. 8 is another cross-sectional view of the dome cover of FIG. 1.

FIG. 9 is another cross-sectional view of the dome cover of FIG. 1.

FIG. 10 is a cross-sectional view of another embodiment of multiple dome covers that are stacked.

FIG. 11 is another cross-sectional view of stacked dome covers of FIG. 1.

FIG. 12 is an isometric view of an embodiment of stacked dome covers.

### DETAILED DESCRIPTION OF THE PREFERRED EMBODIMENTS

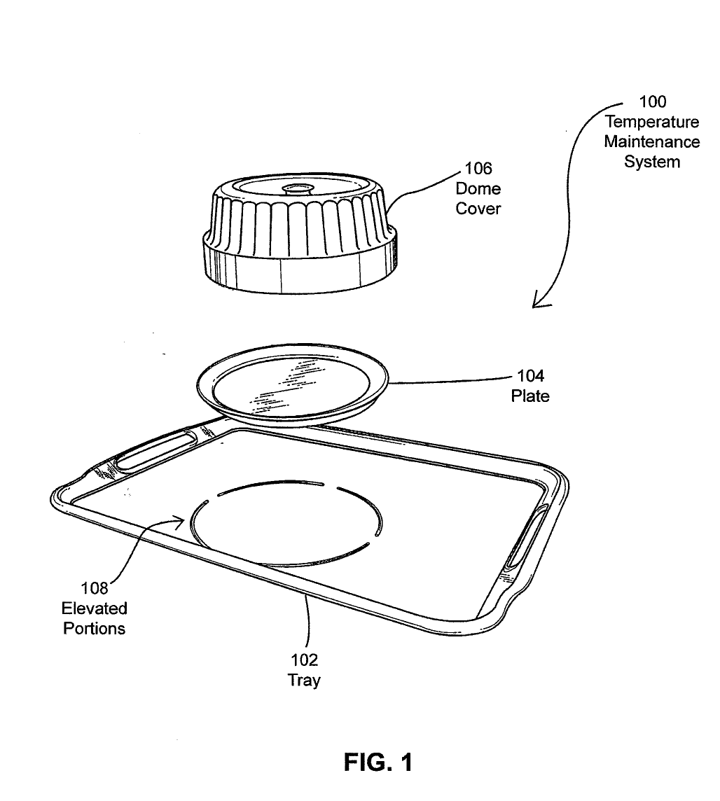

FIG. 1 is an isometric assembly view of temperature maintenance system 100. Temperature maintenance system 100 eliminates the cost and maintenance of an induction heater. An induction heater is an electronic device that sits under a plate while a customer or patient is eating so that the plate will remain warm, thereby keeping the customer or patient's food warm. Temperature maintenance system 100 allows virtually no maintenance and does not create the danger of a hot and heavy induction system base for a customer to juggle.

It should be noted that the term heat is defined as energy transferred between objects due to a temperature difference. In other words, the term heat is not limited to warmth but encompasses a broad range of temperatures including temperatures that are considered to be cold. For example, temperature maintenance system 100 assists in substantially maintaining a desired temperature for an extended period of time by retaining heat which may include hot, cold, and temperatures in between hot and cold. The temperature maintenance system is capable of substantially retaining heat for at least ninety minutes, thus eliminating the need to prepare a customer another meal due to food not having an appropriate temperature to serve to a customer.

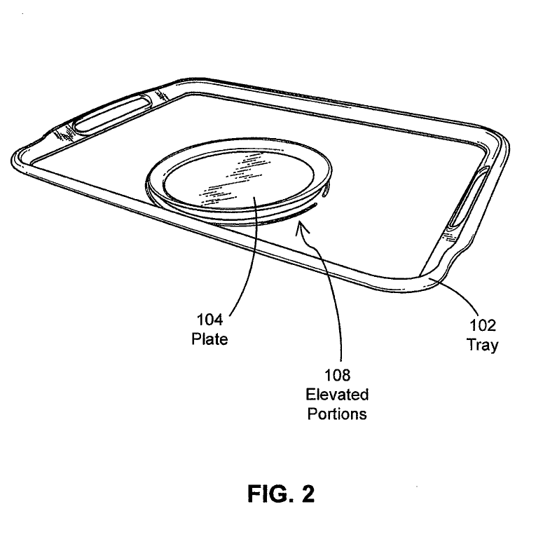

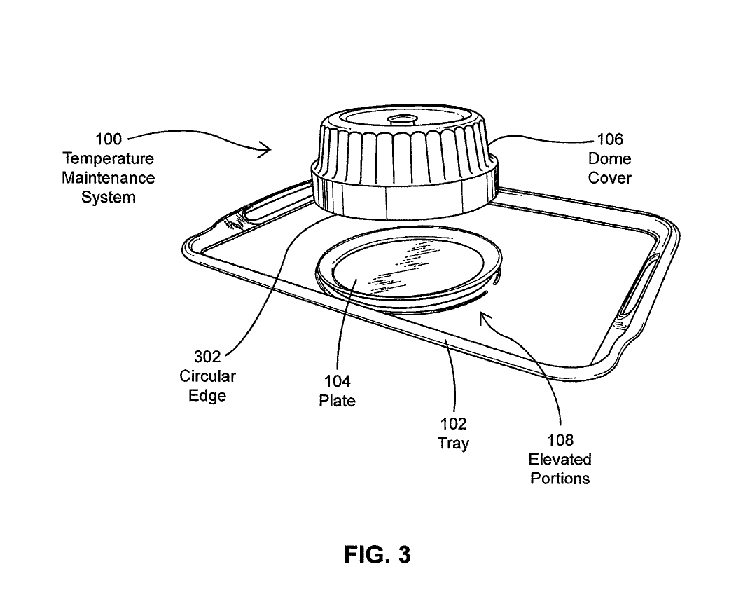

Temperature maintenance system 100 comprises tray 102, plate 104, and dome cover 106. In use, temperature maintenance system 100 allows plate 104 and dome cover 106 to remain in place during transit as a result of elevated portions 108 located on tray 102. For example, (referring to FIGS. 2 and 3), plate 104 is placed inside elevated portions 108, and dome cover 106 is placed on tray 102 so that elevated portions 108 fit inside the circular edge 302 (FIG. 3) of dome cover 106. Elevated portions 108 on tray 102 prevent the dome cover and plate from sliding during transit.

As shown in FIG. 1, elevated portions 108 are located in the front portion of tray 102 so that when a customer receives their meal, the plate is positioned as an appealing presentation and is located a convenient distance, allowing the customer easy access to their meal. In other words, the customer does not have to reach a far distance on tray 102 to retrieve their meal on plate 104. This can be important in certain settings such as hospitals and nursing homes wherein a patient may have limited mobility. Additionally, tray 102 and dome cover 106 may be constructed of plastic and be of any color or design. For example, hotels or hospitals may have a certain logo or color scheme that they may wish to employ temperature maintenance system 100. Any hard plastic may be used such as polypropylene.

In accordance with the temperature maintenance system 100 of FIG. 1, temperatures of food are maintained by heating or cooling plate 104, i.e., increasing or decreasing the temperature of plate 104. Plate 104 has special heat retaining properties (hot and cold), and can be used in a microwave. Plate 104 has an increased amount of aluminum oxide added which adds to the mass as well as the density and hardness of plate 104 and thus assists in the heat retaining properties of plate 104. Plate 104 is approximately forty three percent heavier than standard plates and may have as much as eight times the amount of aluminum oxide present in the plate in comparison to standard plates containing aluminum oxide. Plate 104 can be purchased from Niagara Ceramics located at 75 Hayes Place Buffalo, N.Y. 14210. In use, the temperature of plate 104 can be increased or decreased (heated or cooled) to maintain the temperature of the food placed on plate 104. Plate 104 can then be placed on tray 102 and dome cover 106 can then cover plate 104 on tray 102. Dome cover can optionally be heated or cooled before being placed over plate 104. Heating dome cover 106 is not essential for temperature maintenance system to maintain temperature properly. However, heating the dome cover 106 can assist in reducing condensation inside dome cover 106 while the temperature maintenance system 100 is waiting to be delivered to a customer. This is mainly the case when the delivery time for meals is extended due to delivering food in a large facility, such as in a large hospital or large hotel such as a conference hotel.

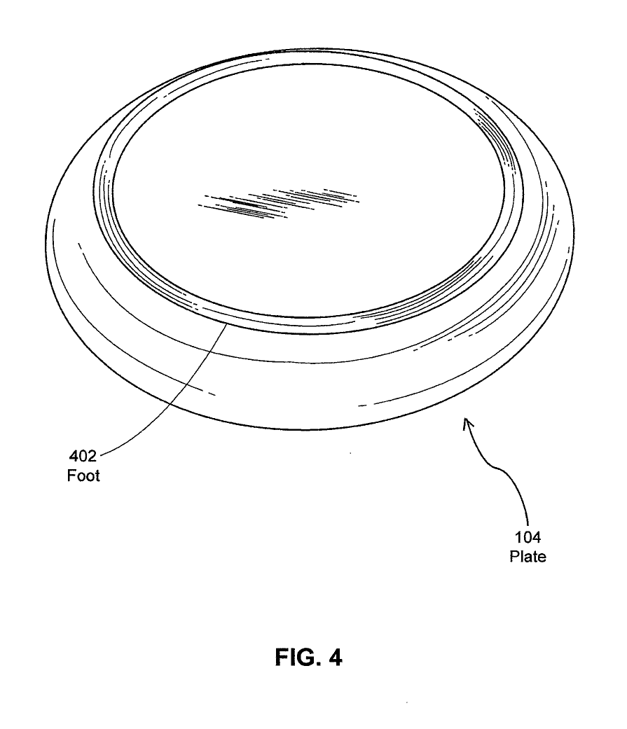

FIG. 4 is an isometric rear view of plate 104. Foot 402 is an elevated portion that holds the weight of plate 104, in addition to prevent sliding of tray 102 (FIG. 3). In other words, elevated portions 108 of tray 102 prevents plate 104 from sliding off of tray 102 by elevated foot 402 of plate 104 being impeded by elevated portions 108 of tray 102, thus preventing plate 104 from sliding around tray 102.

Plate 104, as illustrated in FIG. 4, employs an extra hard glaze that is twice fired that can help prevent the accumulation of metal on foot 402 when plate 104 slides across a metal surface such as those commonly found in industrial kitchens. When plates slide across a metal surface, it is common for the foot of a plate to accumulate metal, thus ruining the metal surface. Hence, the extra hard glaze on foot 402 of plate 104 helps prevent metal counter tops in kitchens from becoming destroyed over time. Plate 104 can be an appealing ivory color, but may also be various different colors, or have multiple colors and logos (including words) if desired.

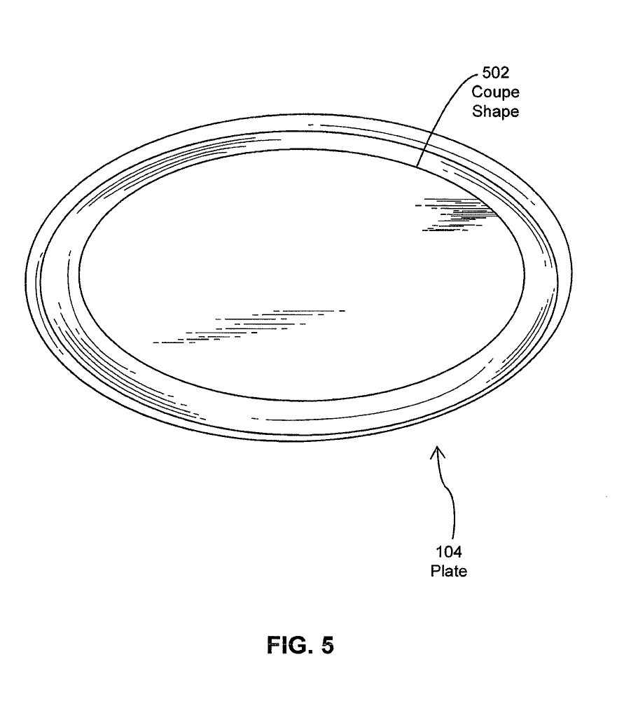

FIG. 5 is a front isometric view of plate 104. Plate 104 is in a general coupe shape 502 to allow generous portions of food to be disposed on plate 104. In other words, the coupe shape 502 of plate 104 assists in retaining food on plate 104 but also allows additional space on tray 102 (FIG. 3). For example, an eight inch plate 104 will give the same eating and plating surface as a traditional nine inch plate, while saving space on tray 102 (illustrated in FIGS. 1-3). In addition, if plate 104 is constructed to be eight inches, plate 104 is constructed to accommodate standard nine inch plate heaters, thereby saving the consumer money.

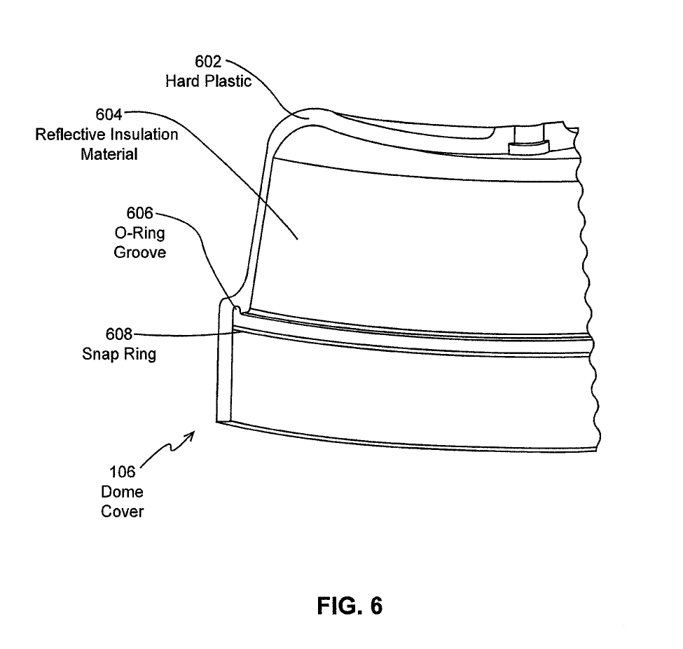

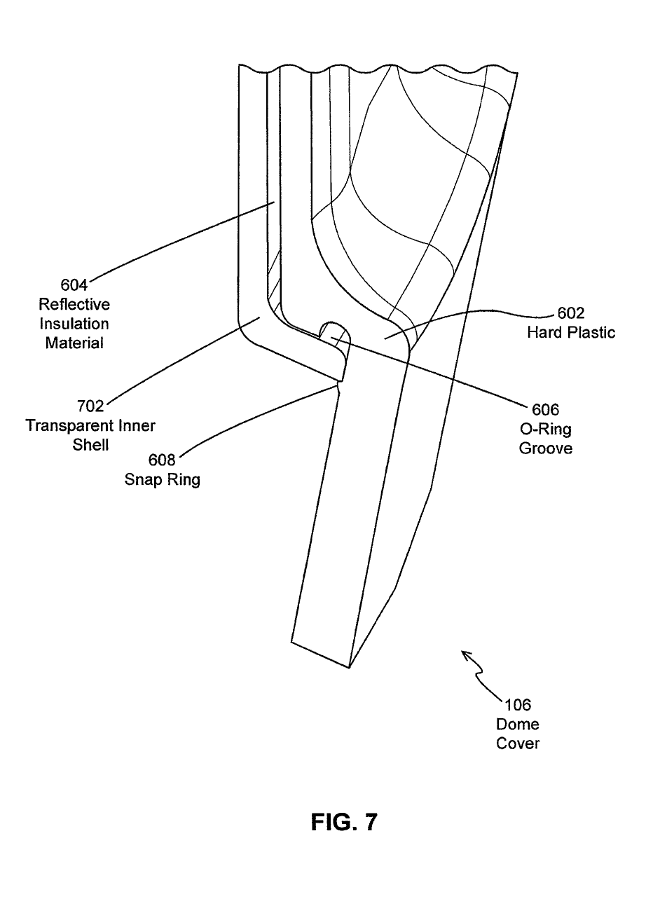

FIG. 6 is a side view of dome cover 106. Dome cover 106 has a layer of reflective insulation material 604 that is breathable which reduces condensation on the inside surface of hard plastic material 602. Reflective insulation material 604 can be made out of a material such as Temptrol® which can be purchased from innovative insulation packaging at 6200 West Pioneer Parkway, Arlington, Tex. 76013. Below the reflective insulation material 604, there is a groove 606 for a silicone o-ring. FIG. 6 also illustrates a snap ring 608 used to hold an inner layer that covers reflective insulation material 604, as illustrated in FIG. 7.

FIG. 7 illustrates a partial cross sectional view of dome cover 106. Snap ring 608 holds transparent inner shell 702 in place over reflective insulation material 604. Transparent inner shell 702 is capable of transmitting infrared radiation frequencies between the plate 104 (FIG. 4) and reflective insulation material 604. In other words, infrared radiation is synonymous with heat radiation. As plate 104 (FIG. 7) radiates heat, transparent inner shell 702 allows infrared radiation from plate 104 (FIG. 7) to radiate through transparent inner shell 702, and thus reflect off of reflective insulation material 604, thereby radiating back through transparent inner shell towards plate 104 (FIG. 4), thus maintaining a substantially constant temperature of the food (not shown) on plate 104 (FIG. 7). Dome cover 106 is constructed so there a void of space between hard plastic 602 and transparent inner shell 702 which allows room for reflective insulation material 604. O-ring groove 606 has a void space to accommodate a silicone o-ring (not shown) that has some elasticity to properly hold transparent inner shell 702 inside dome cover 106.

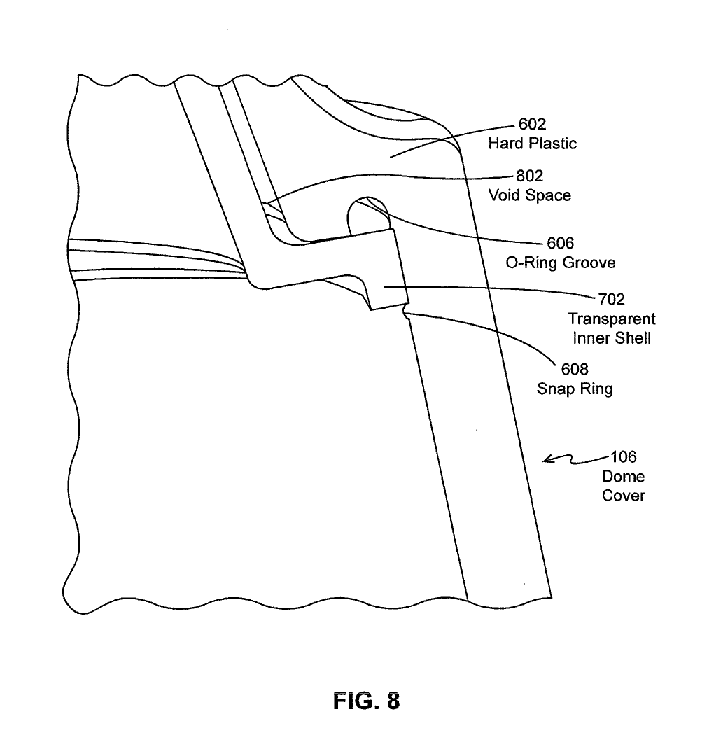

FIG. 8 is a close up view of FIG. 7 illustrating o-ring groove 606 and snap ring 608. FIG. 8 also illustrates void space 802 created between transparent inner shell 702 and hard plastic 602.

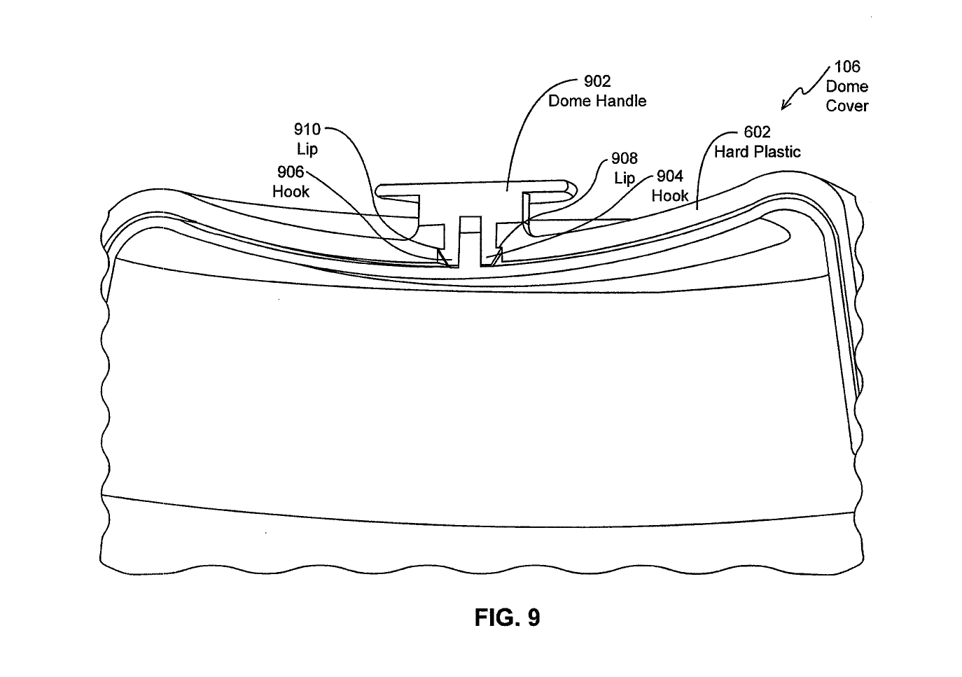

FIG. 9 is a cross sectional view of dome cover 106. Dome handle 902 is inserted into an opening in hard plastic 602 so that hooks 904, 906 get caught on lip 908, 910, thereby fixing dome handle 902 to hard plastic 602. Dome handle 902 is optional and does not have to be employed. In the case that dome handle 902 is not used, hard plastic 602 is a smooth, solid surface.

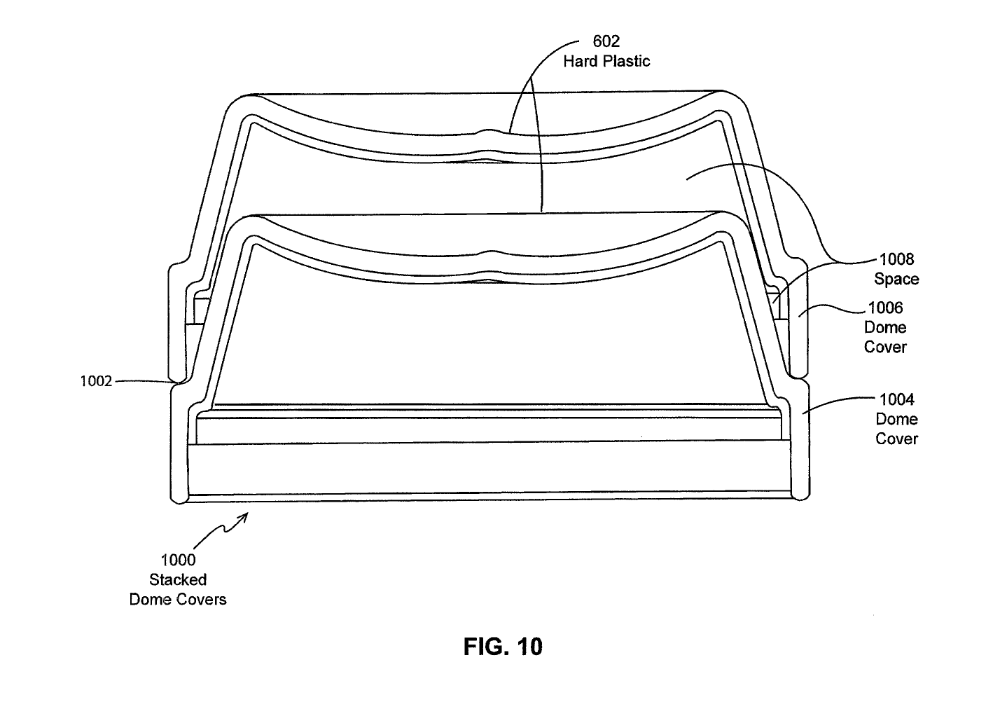

FIG. 10 is a cross sectional view of stacked dome covers 1000. Dome covers 1004, 1006 are capable of being stacked upon one another, thus saving space in a work area. Dome cover 1006 is supported by edge 1002 of dome cover 1004. A space 1008 is provided between dome cover 1004 and dome cover 1006 so that dome cover can be easily lifted from dome cover 1004.

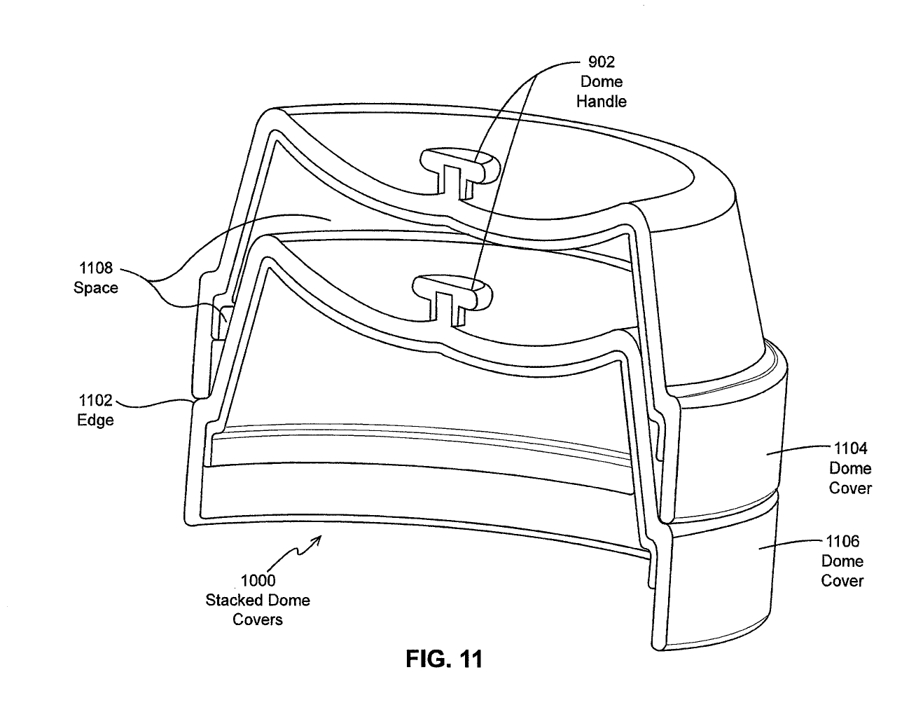

FIG. 11 illustrates stacked dome covers 1100. Dome covers 1106, 1104, have a dome handle 902 (illustrated in FIG. 9). Dome cover 1104 is supported by edge 1102 of dome cover 1106. Space 1108 is provided between dome cover 1106 and dome cover 1104 so that dome cover 1104 can be easily lifted from dome cover 1106. Space 1108 also allows room for the employment of dome handle 902.

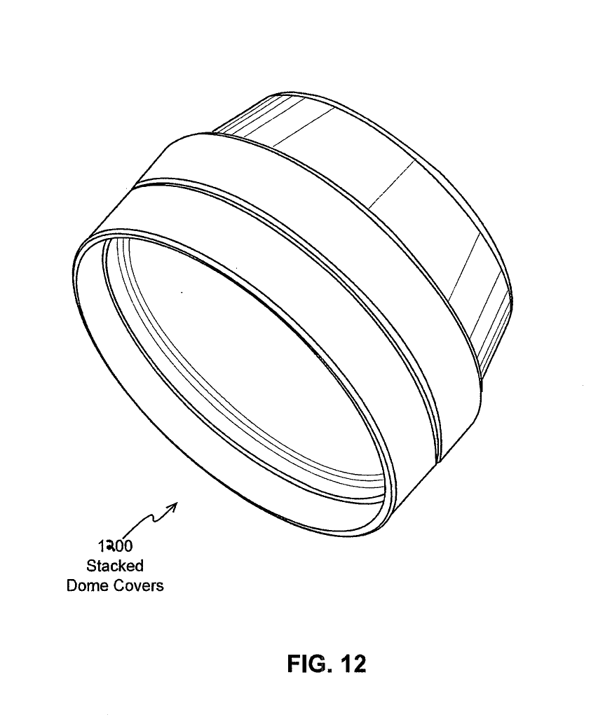

FIG. 12 is an isometric view of stacked dome covers 1200 illustrating how closely dome covers are stacked together. There is a great benefit to having additional space in a work area, such as a food preparation area. Thus, stacked dome covers can provide space, allowing more surface area for food preparation and presentation.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A dome for maintaining the temperature of food comprising:
a cover having a plastic shell comprising a first inside portion and a second outside portion;
a reflective insulated layer adjacently disposed in said inside portion of said plastic shell;
a transparent inner shell capable of radiating infrared radiation, said transparent inner shell adjacently disposed over said reflective insulated layer so that heat is reflected from said reflective insulated layer causing said first cover to retain heat within an inside portion of said cover when said first cover is disposed on a surface.

2. The dome of claim 1 further comprising:
a silicone ring disposed in a groove of said inside portion of said plastic shell so that said silicone ring assists in retaining said clear layer over said reflective insulated material.

3. The dome of claim 1 further comprising:
a snap ring located on said inside portion of said plastic shell so that said snap ring assists in retaining said clear layer adjacent to said reflective insulated layer.

4. The dome of claim 1 further comprising:
a handle disposed in an open portion of said first cover.

5. The dome of claim 4 wherein said plastic shell is formed so that an additional cover can be stacked on said cover without binding.

6. The dome of claim 1 wherein said plastic shell is formed so that an additional cover can be stacked on said cover without binding.

7. A method for maintaining the temperature of food comprising:
providing a cover having a plastic shell having an inside portion and an outside portion;
providing a reflective insulated layer adjacently disposed in said inside portion of said plastic shell;
providing a transparent inner shell capable of radiating infrared radiation adjacently disposed over said reflective insulated layer so that heat is reflected from said reflective insulated layer;
placing said cover over said food so that said cover retains heat in said cover when said cover is disposed on a surface.

8. The method of claim 7 further comprising:
providing a silicone ring disposed in a groove of said inside portion of said plastic shell so that said silicone ring retains said transparent inner shell over said reflective insulated material.

9. The method of claim 7 further comprising:
providing a snap ring located on said inside portion of said plastic shell so that said snap ring assists in retaining said transparent inner shell adjacent to said reflective insulated layer.

10. The method of claim 7 further comprising:
providing a handle disposed in an open portion of said first cover.

11. The method of claim 10 wherein said step of providing a cover further comprises:
providing a cover having a plastic shell that can be stacked on similar plastic shells without binding.

12. The method of claim 7 wherein said step of providing a cover further comprises:
providing a cover having a plastic shell that can be stacked on similar plastic shells without binding.

13. A temperature maintenance system for maintaining the temperature of food comprising:
a ceramic plate containing heat activated materials to help retain heat within said ceramic plate so that said ceramic plate assists in providing a substantially constant temperature of said food disposed on said ceramic plate;
a dome cover having a plastic surface that does not melt when exposed to an increase in temperature that is approximately equal to the temperature of said food disposed on said plate;
a reflective insulated layer disposed adjacent to said plastic surface;
a transparent inner shell capable of radiating infrared radiation disposed adjacent to said reflective insulating layer so that said reflective insulating layer radiates heat towards said ceramic plate.

14. The temperature maintenance system of claim 13 further comprising said reflective insulated material having ventilative properties to reduce condensation inside said dome cover.

15. The temperature maintenance system of claim 13 further comprising:
a tray having elevated portions so that said ceramic plate is disposed inside said elevated portions to prevent said ceramic plate from sliding on said tray;
said dome cover disposed around said elevated portions to prevent said ceramic plate from shifting during transit.

16. A method of maintaining the temperature of food comprising:
providing a ceramic plate containing heat activated materials to help retain heat within said ceramic plate so that said ceramic plate assists in providing a substantially constant temperature of said food disposed on said ceramic plate;
providing a dome cover having a plastic surface that does not melt when exposed to an increase in temperature that is approximately equal to the temperature of said food disposed on said plate;
providing a reflective insulated layer disposed adjacent to said plastic surface;
providing a transparent inner plastic shell that radiates infrared radiation, said transparent inner plastic shell disposed adjacent to said reflective insulating layer so that said reflective insulating layer radiates heat towards said ceramic plate.

17. The method of claim 16 further comprising:
providing said reflective insulated material having ventilative properties to reduce condensation inside said dome cover.

18. The method of claim 16 further comprising:
providing a tray having elevated portions so that said ceramic plate is disposed inside said elevated portions to prevent said ceramic plate from sliding on said tray;
disposing said dome cover around said elevated portions to prevent said ceramic plate from shifting during transit.

19. A method for transporting food on a tray comprising:
providing a plate having a protruding foot located on a rear portion of said plate;
providing a dome cover having edges so that said edges rest on said tray;
providing elevated portions on said tray so that said protruding foot of said plate prevent said plate from sliding on said tray when said plate is disposed within said elevated portions and said elevated portions prevent said dome cover from shifting on said tray during transit when said dome cover is disposed on an outer portion of said elevated portions of said tray.
